(19) United States
(12) Patent Application Publication
(10) Pub. No.: US 2015/0055018 A1
(43) Pub. Date: Feb. 26, 2015

(54) IMAGE PROCESSING DEVICE, IMAGE DISPLAY DEVICE, IMAGE PROCESSING METHOD, AND STORAGE MEDIUM

(71) Applicant: Sharp Kabushiki Kaisha, Osaka (JP)

(72) Inventor: Toyohisa Matsuda, Osaka (JP)

(21) Appl. No.: 14/390,259

(22) PCT Filed: Apr. 5, 2013
(86) PCT No.: PCT/JP2013/060505

§ 371 Date: Oct. 2, 2014

(30) Foreign Application Priority Data
Apr. 5, 2012 (JP) 2012-086608

(51) Int. Cl. H04N 9/64; H04N 9/76

(52) U.S. Cl. CPC H04N 9/646; H04N 9/76
USPC 348/599

(57) ABSTRACT

A detail improvement processing section (13) includes (i) a maximum value calculation processing section (17) configured to calculate a maximum value of pixel values of respective of a target pixel and peripheral pixels around the target pixel, (ii) a minimum value calculation processing section (18) configured to calculate a minimum value of the pixel values, (iii) a high-frequency component generation processing section (19) configured to calculate a high-frequency component on the basis of the pixel value of the target pixel, the maximum value, and the minimum value, and (iv) a mixing processing section (20) configured to correct the pixel value of the target pixel using the high-frequency component.

### TECHNICAL FIELD

The present invention relates to an image processing apparatus capable of processing an image with detail of the image improved, an image processing method, a computer program, and a storage medium.

### BACKGROUND ART

In a case where a static image or a moving image, which is displayed sufficiently clearly at one magnification, is subjected to an enlargement process, clarity and detail of the static image or the moving image are sometimes impaired, and consequently a blurred static image or moving image is displayed. Clarity of an image can be improved by subjecting the image to an enhancement process such as an unsharp mask process before an enlargement process. However, the enhancement process thickens a contour of the image or creates overshoot and undershoot around the contour of the image. The image subjected to the enhancement process and then the enlargement process becomes remarkably odd.

Such thickening of the contour can be reduced by subjecting the image to a filter process in a small block size (mask size) such as 3×3. However, the filter process in the small mask size monotonizes a filter frequency response. This strengthens an enhancement effect on an unnecessary high-frequency component than on a significant frequency band. Strengthening of the enhancement effect on the significant frequency band causes further strengthening of the enhancement effect on the unnecessary high-frequency component.

Japanese Patent No. 4099936 (Registered on Mar. 28, 2008) realizes a definition correction suitable for an image by employing Expression (1) below. Expression (1) is obtained by (i) multiplying, by a global enhancement constant value K for the whole image and a local enhancement constant value k(y, x) for each pixel, a difference value between an input image RGB_{IN} and an image RGB_{SM} obtained by subjecting the input image RGB_{IN} to a smoothing process, and (ii) adding a result of the multiplication to the input image RGB_{IN}. Each of the global enhancement constant value K and the local enhancement constant value k(y, x) is calculated based on color edge information which is obtained from an average value of a color distance between a target pixel and peripheral pixels around the target pixel.

[Expression 1]

R_{OUT}=R_{IN}(y,x)+K×k(y,x)×(R_{IN}(y,x)−R_{SM}(y,x))

G_{OUT}=G_{IN}(y,x)+K×k(y,x)×(G_{IN}(y,x)−G_{SM}(y,x))

B_{OUT}=B_{IN}(y,x)+K×k(y,x)×(B_{IN}(y,x)−B_{SM}(y,x)) (1)

where (i) R_{IN}(y, x), G_{IN}(y, x) and B_{IN}(y, x) each represent an input pixel value at a coordinate (y, x), (ii) R_{SM}(y, x), G_{SM}(y, x) and B_{SM}(y, x) each represent a pixel value subjected to the smoothing process at the coordinate (y, x), and (iii) R_{OUT}(y, x), G_{OUT}(y, x) and B_{OUT}(y, x) each represent a process result at the coordinate (x, y).

### SUMMARY OF INVENTION

### Technical Problem

According to a technique of Japanese Patent No. 4099936, it is possible to carry out a definition correction in consideration of sharpness of a whole image and sharpness of each pixel by making an enhancement at a global enhancement constant value K and a local enhancement constant value k(y, x) each of which is calculated as an enhancement constant value of an unsharp mask on the basis of color edge information. However, similar to a conventional unsharp mask process, the technique of Japanese Patent No. 4099936 thickens a contour of an image by carrying out a smoothing process in a large mask size so that a sufficient enhancement effect is brought about. In a case where the image whose contour is thickened is subjected to an enlargement process, the image becomes remarkably odd. It is possible to reduce the thickening of the contour by reducing the mask size in which a smoothing process is carried out. However, such a smoothing process in a small mask size monotonizes a frequency response. This strengthens an enhancement effect on an unnecessary high-frequency component than on a significant frequency band. Strengthening of the enhancement effect on the significant frequency band causes further strengthening of the enhancement effect on the unnecessary high-frequency component.

The present invention was made in view of the problem, and an object of the present invention is to provide (i) an image processing apparatus capable of creating image data of an image whose detail is improved without thickening a contour of the image, (ii) an image display apparatus, (iii) an image processing method, (iv) a computer program, and (v) a storage medium.

### Solution to Problem

In order to attain the object, an image processing apparatus of the present invention is configured to include a detail correction processing section configured to correct detail of inputted image data, the detail correction processing section including: a maximum value calculation processing section configured to calculate, for each pixel of the inputted image data, a maximum value of pixel values of a block of a plurality of pixels that include a target pixel; a minimum value calculation processing section configured to calculate, for each pixel of the inputted image data, a minimum value of the pixel values of the block of the plurality of pixels that include the target pixel; a high-frequency component generation processing section configured to calculate, for each pixel of the inputted image data, a high-frequency component of the target pixel on the basis of (i) the pixel value of the target pixel, (ii) the maximum value calculated for the target pixel, and (iii) the minimum value calculated for the target pixel; and a mixing processing section configured to correct, for each pixel of the inputted image data, the pixel value of the target pixel, using the high-frequency component calculated for the target pixel.

### Advantageous Effects of Invention

The image processing apparatus of the present invention is configured so that the detail correction processing section includes: a maximum value calculation processing section configured to calculate, for each pixel of the inputted image data, a maximum value of pixel values of a block of a plurality of pixels that include a target pixel; a minimum value calculation processing section configured to calculate, for each pixel of the inputted image data, a minimum value of the pixel values of the block of the plurality of pixels that include the target pixel; a high-frequency component generation processing section configured to calculate, for each pixel of the inputted image data, a high-frequency component of the target pixel on the basis of (i) the pixel value of the target pixel, (ii) the maximum value calculated for the target pixel, and (iii) the minimum value calculated for the target pixel; and a mixing processing section configured to correct, for each pixel of the inputted image data, the pixel value of the target pixel, using the high-frequency component calculated for the target pixel.

According to the configuration, the detail correction processing section calculates the maximum value of and the minimum value of the pixel values of the block of the respective plurality of pixels that include the target pixel, and then calculates the high-frequency component on the basis of the target pixel value, the maximum value and the minimum value. In a case where a small block size as the block is selected, it is possible to effectively calculate (generate), in the small block size, a high-frequency component which brings clarity. By correcting a pixel value of a target pixel using this high-frequency component, it is possible to improve detail without (i) thickening a contour and (ii) enhancing an unnecessary frequency band.

According to the configuration, it is possible to create image data of an image whose detail is improved without thickening a contour of the image.

### BRIEF DESCRIPTION OF DRAWINGS

FIG. 1 is a block diagram illustrating a configuration of a television broadcasting receiver of an embodiment of the present invention.

FIG. 2 is a block diagram illustrating a configuration of a video signal processing section included in the television broadcasting receiver.

FIG. 3 is a block diagram illustrating a configuration of a detail improvement processing section included in the video signal processing section.

FIG. 4 is a flowchart illustrating a flow of processes which are carried out by a maximum value calculation processing section, a minimum value calculation processing section, and a high-frequency component generation processing section all of which sections are included in the detail improvement processing section.

FIG. 5 is a view illustrating a target pixel and peripheral pixels around the target pixel, the target pixel and the peripheral pixels constituting a block of 3×3 pixels.

(a) and (b) of FIG. 6 are views illustrating an example of a high-frequency component generation process which is carried out by the high-frequency component generation processing section.

FIG. 7 is a view illustrating a flowchart of a mixing process carried out by a mixing processing section.

FIG. 8 is a view illustrating an example of a weight coefficient table weightLUT which shows a relation between a dynamic range Range and a weight coefficient.

(a) of FIG. 9 is a view illustrating an example of an input image. (b) of FIG. 9 is a view illustrating an example of an output image outputted from the detail improvement processing section. (c) of FIG. 9 is a view illustrating an example of a high-frequency component generated by the high-frequency component generation processing section.

FIG. 10 is a view illustrating an overall flow of processes which are carried out in the detail improvement processing section.

FIG. 11 is a block diagram illustrating a configuration of a detail improvement processing section of another embodiment of the present invention.

FIG. 12 is a view illustrating an example of a filter used by a high-pass filter processing section included in the detail improvement processing section of the another embodiment.

FIG. 13 is a view illustrating a flowchart of processes which are carried out by a mixing processing section included in the detail improvement processing section of the another embodiment.

FIG. 14 is a view illustrating an overall flow of processes which are carried out in the detail improvement processing section of the another embodiment.

FIG. 15 is a view illustrating a multi-display.

### DESCRIPTION OF EMBODIMENTS

The following description will discuss in detail the present invention with reference to the drawings which illustrate embodiments of the present invention. The following embodiments of the present invention will explain a television broadcasting receiver 1 as an example of an image display apparatus of the present invention, and explains, as an example of an image processing apparatus of the present invention, a video signal processing section 42 included in the television broadcasting receiver 1. Note that the word “image” includes a moving image in the embodiments.

(Television Broadcasting Receiver)

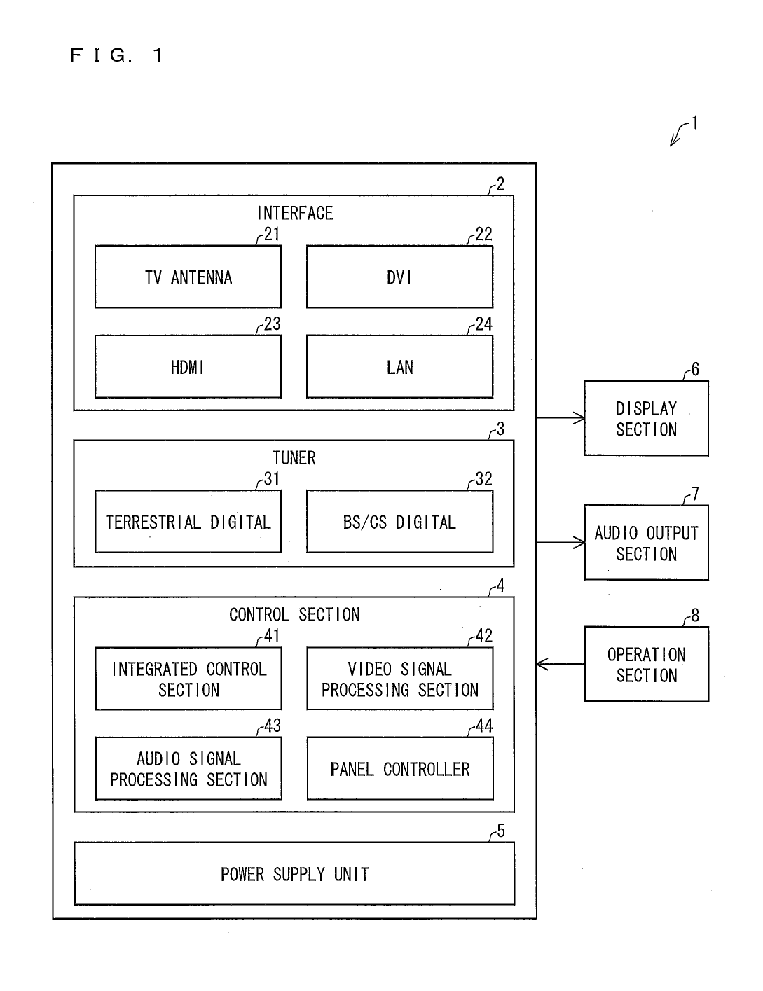

FIG. 1 is a block diagram illustrating a configuration of the television broadcasting receiver 1 (image display apparatus) of the present embodiment. As illustrated in FIG. 1, the television broadcasting receiver 1 is provided with an interface 2, a tuner 3, a control section 4, a power supply unit 5, a display section 6, an audio output section 7, and an operation section 8.

The interface 2 includes (i) a TV antenna 21, (ii) a DVI (Digital Visual Interface) terminal 22 and an HDMI (High-Definition Multimedia Interface) (Registered Trademark) terminal 23 each of which the television broadcasting receiver 1 uses to establish a serial communication based on TMDS (Transition Minimized Differential Signaling), and (iii) a LAN terminal 24 which the television broadcasting receiver 1 uses to establish a communication according to a communication protocol such as TCP (Transmission Control Protocol) or UDP (User Datagram Protocol). In response to an instruction from an integrated control section 41, the television broadcasting receiver 1 uses the interface 2 to transmit or receive data to/from an external device connected to the DVI terminal 22, the HDMI terminal 23 or the LAN terminal 24.

The tuner 3 is connected to the TV antenna 21. A broadcast signal received by the TV antenna 21 is supplied to the tuner 3. The broadcast signal includes video data, audio data, etc. The present embodiment describes a case where the tuner 3 includes a terrestrial digital tuner 31 and a BS/CS digital tuner 32. The case is illustrative only.

The control section 4 includes (i) the integrated control section 41 which controls blocks (sections) of the television broadcasting receiver 1 in an integrated manner, (ii) the video signal processing section 42 (image processing apparatus), (iii) an audio signal processing section 43, and (iv) a panel controller 44.

The video signal processing section 42 carries out a predetermined process with respect to video data supplied from the interface 2, so as to generate video data (video signal) to be displayed on the display section 6.

The audio signal processing section 43 carries out a predetermined process with respect to audio data supplied from the interface 2, so as to generate an audio signal.

The panel controller 44 controls the display section 6 to display an image based on video data outputted from the video signal processing section 42.

The power supply unit 5 controls electric power which is externally supplied. In response to an operation instruction entered from a power supply switch of the operation section 8, the integrated control section 41 controls the power supply unit 5 to supply or not to supply electric power to the television broadcasting receiver 1. In a case where an operation instruction for turning on the television broadcasting receiver 1 is entered from the power supply switch, electric power is supplied to the whole television broadcasting receiver 1. In contrast, in a case where an operation instruction for turning off the television broadcasting receiver 1 is entered from the power supply switch, electric power stops being supplied to the television broadcasting receiver 1.

Examples of the display section 6 include a liquid crystal display device (LCD) and a plasma display panel. The display section 6 displays an image based on video data outputted from the video signal processing section 42.

Upon reception of an instruction from the integrated control section 41, the audio output section 7 outputs an audio signal generated by the audio signal processing section 43.

The operation section 8 includes at least the power supply switch and a change-over switch. The power supply switch is used to enter an operation instruction for turning on or off the television broadcasting receiver 1. The change-over switch is used to enter an operation instruction for determining a broadcast channel received by the television broadcasting receiver 1. In response to a pressing of the power supply switch or the change-over switch, the operation section 8 gives, to the integrated control section 41, an operation instruction corresponding to the pressing of the power supply switch or the change-over switch.

The above has described a case where the operation section 8 of the television broadcasting receiver 1 is operated by a user. Alternatively, the operation section 8 may be configured to (i) be included in a remote controller which is wirelessly communicable with the television broadcasting receiver 1 and (ii) transmit, to the television broadcasting receiver 1, an operation instruction corresponding to a pressing of the power supply switch or the change-over switch. In this case, a communication medium which the remote controller uses to communicate with the television broadcasting receiver 1 may be infrared rays or electromagnetic waves.

(Video Signal Processing Section)

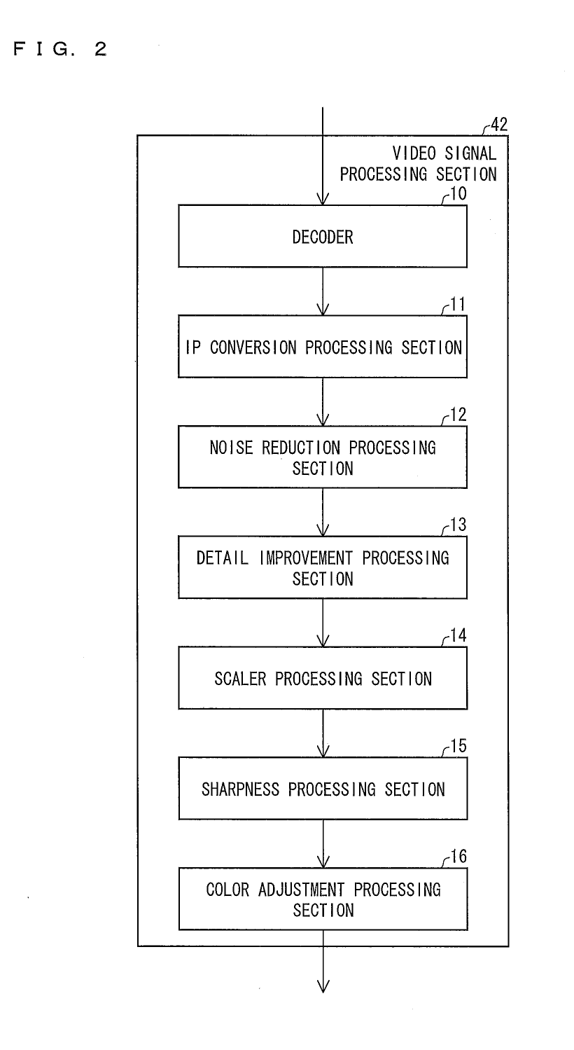

FIG. 2 is a block diagram illustrating a configuration of the video signal processing section 42. As illustrated in FIG. 2, the video signal processing section 42 includes a decoder 10, an IP conversion processing section 11, a noise processing section 12, a detail improvement processing section (detail correction processing section) 13, a scaler processing section 14, a sharpness processing section 15, and a color adjustment processing section 16. Note that the present embodiment describes a case where each of the processing sections of the video signal processing section 42 processes R, G, and B signals. The case is illustrative only. Each of the processing sections of the video signal processing section 42 may be configured to process luminance signals.

The decoder 10 decodes compressed video stream to generate video data, and then supplies the video data to the IP conversion processing section 11. Upon reception of the video data from the decoder 10, the IP conversion processing section 11, if necessary, converts a scanning system of the video data from an interlaced scanning system to a progressive scanning system. The noise processing section 12 carries out various noise reduction processes for reducing (suppressing) (i) a sensor noise included in the video data supplied from the IP conversion processing section 11 and (ii) a compression artifact generated as a result of a compression.

The detail improvement processing section 13 carries out a detail improvement process with respect to the video data supplied from the noise processing section 12 so that an image which has been subjected to an enlargement process becomes a high-definition image. The scaler processing section 14 carries out, in accordance with the number of pixels of the display section 6, a scaling process with respect the video data supplied from the detail improvement processing section 13. The sharpness processing section 15 carries out a sharpness process for clarifying the image based on the video data supplied from the scaler processing section 14. The color adjustment processing section 16 carries out, with respect to the video data supplied from the sharpness processing section 15, a color adjustment process for adjusting contrast, color saturation, etc.

Note that the integrated control section 41 controls a storage section (not illustrated) to store as appropriate video data with respect to which the video signal processing section 42 has carried out various processes.

(Detail Improvement Processing Section)

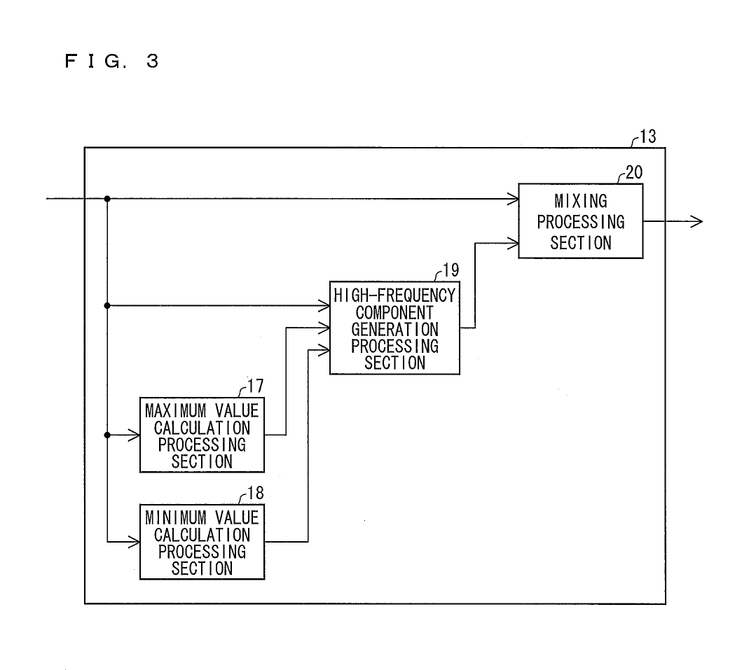

FIG. 3 is a block diagram illustrating a configuration of the detail improvement processing section 13. The detail improvement processing section includes a maximum value calculation processing section 17, a minimum value calculation processing section 18, a high-frequency component generation processing section 19, and a mixing processing section 20.

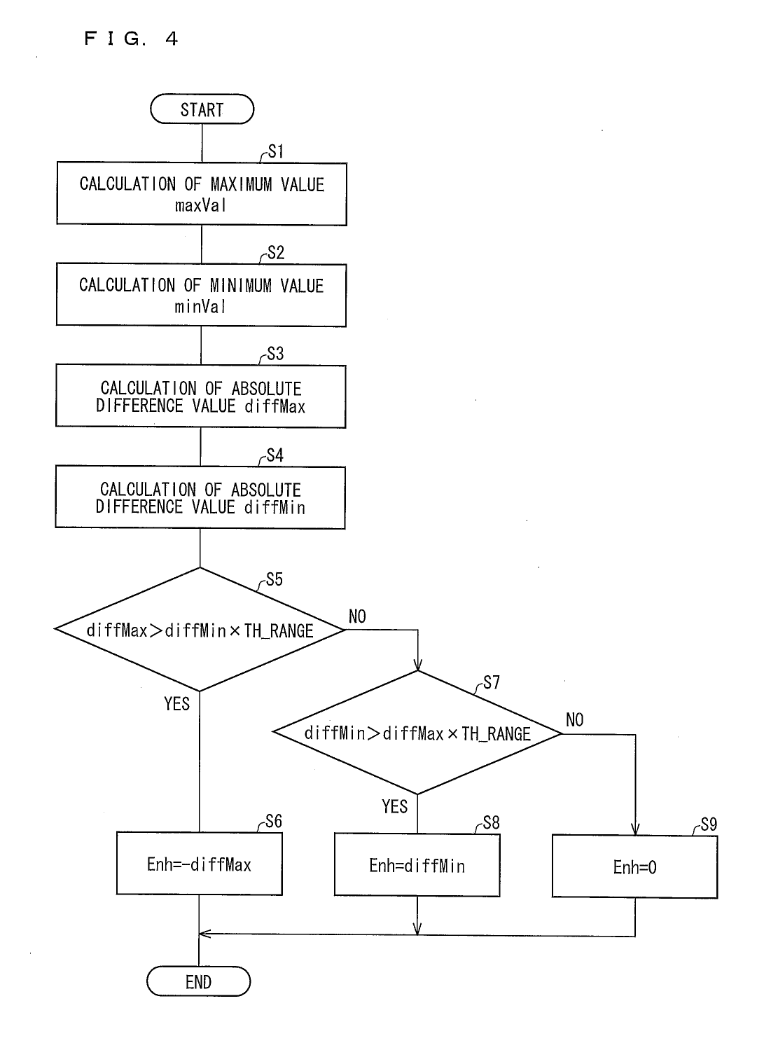

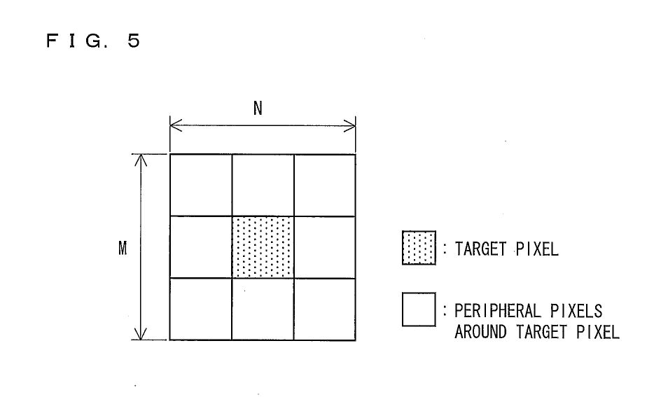

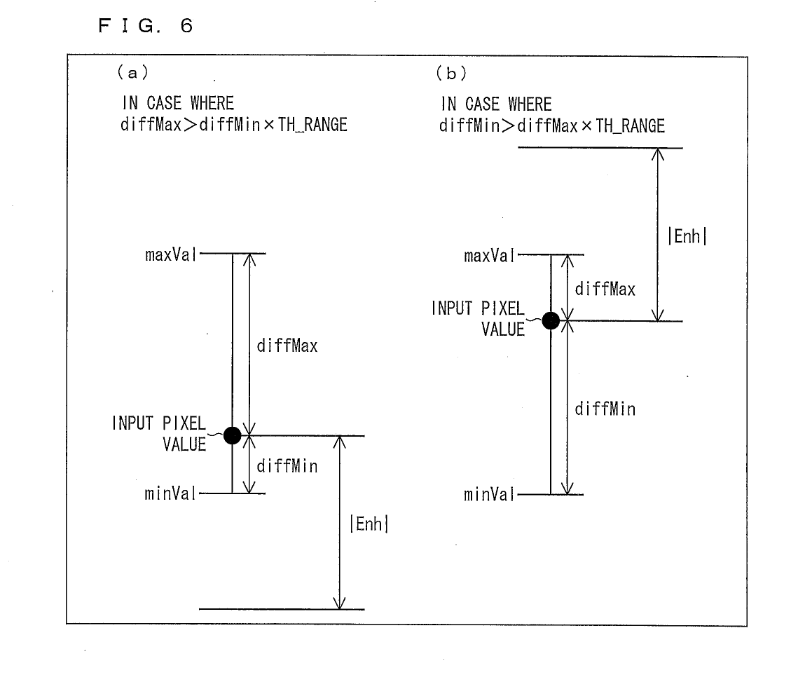

The following description will discuss, with reference to a flowchart of FIG. 4, a flow of processes which are carried out by the maximum value calculation processing section 17, the minimum value calculation processing section 18, and the high-frequency component generation processing section 19. The maximum value calculation processing section 17 calculates, for each pixel (input pixel) included in inputted image data, a maximum value of pixel values of respective M×N pixels (a block of M×N pixels, an M×N pixel window) including a target pixel in a center of the M×N pixels (Step 1, hereinafter abbreviated to S1). FIG. 5 illustrates a target pixel and peripheral pixels around the target pixel in a case where M=N=3. The maximum value calculation processing section 17 calculates, with reference to the peripheral pixels, according to Expression (2) below, a maximum value maxVal of the pixel values of the respective M×N pixels including the target pixel in the center of the M×N pixels.

$$[ Expression 2 ]$$

$$max Val = {MAX}_{- M \text{/} 2 \leq i \leq M \text{/} 2} {MAX}_{- N \text{/} 2 \leq j \leq N \text{/} 2} IN ( y + i , x + j ) \qquad ( 2 )$$

where IN(y, x) represents a pixel value (density in the present embodiment) of a pixel at a coordinate (y, x) of inputted image data. Note that the pixel value does not represent a position coordinate of the pixel, but represents a value which falls within a range from 0 to 255 in a case where the inputted image data is 8-bit data.

Next, the minimum value calculation processing section 18 calculates, for each input pixel, a minimum value of the pixel values of the respective M×N pixels including the target pixel in the center of the M×N pixels (S2). Similar to the maximum value calculation processing section 17, the minimum value calculation processing section 18 calculates, according to Expression (3) below, a minimum value minVal of the pixel values of the respective M×N pixels including the target pixel in the center of the M×N pixels.

$$[ Expression 3 ]$$

$$min Val = {MIN}_{- M \text{/} 2 \leq i \leq M \text{/} 2} {MIN}_{- N \text{/} 2 \leq j \leq N \text{/} 2} IN ( y + i , x + j ) \qquad ( 3 )$$

Next, the high-frequency component generation processing section 19 generates a high-frequency component for each input pixel with use of (i) a pixel value (input pixel value) of each input pixel, (ii) the maximum value maxVal calculated by the maximum value calculation processing section 17, and (iii) the minimum value minVal calculated by the minimum value calculation processing section 18. Specifically, the high-frequency component generation processing section 19 first calculates, according to Expression (4) below, an absolute difference value diffMax that is an absolute value of a difference between the input pixel value and the maximum value maxVal (S3).

[Expression 4]

diffMax=|maxVal−IN(y,x)| (4)

Note here that |•| in Expression (4) means calculation of an absolute value.

Similar to the calculation of the absolute difference value diffMax, the high-frequency component generation processing section 19 calculates, according to Expression (5) below, an absolute difference value diffMin that is an absolute value of a difference between the input pixel value and the minimum value minVal (S4).

[Expression 5]

diffMin=|minVal−IN(y,x)| (5)

The high-frequency component generation processing section 19 then determines whether or not the absolute difference value diffMax is larger than a first result obtained by multiplying the absolute difference value diffMin by a predetermined constant value TH_RANGE (e.g., 1.5) (S5). In a case where the high-frequency component generation processing section 19 determines that the absolute difference value diffMax is larger than the first result (YES in S5), the high-frequency component generation processing section 19 calculates a high-frequency component Enh according to Expression (6) below (S6).

[Expression 6]

Enh=−diffMax (6)

In a case where the high-frequency component generation processing section 19 determines that the absolute difference value diffMax is equal to or smaller than the first result (NO in S5), the high-frequency component generation processing section 19 determines whether or not the absolute difference value diffMin is larger than a second result obtained by multiplying the absolute difference value diffMax by the predetermined constant value TH_RANGE (e.g., 1.5) (S7). In a case where the high-frequency component generation processing section 19 determines that the absolute difference value diffMin is larger than the second result (YES in S7), the high-frequency component generation processing section 19 calculates a high-frequency component Enh according to Expression (7) below (S8).

[Expression 7]

Enh=diffMin (7)

In a case where the high-frequency component generation processing section 19 determines that the absolute difference value diffMin is equal to or smaller than the second result (NO in S7), the high-frequency component generation processing section 19 sets a high-frequency component Enh to zero according to Expression (8) below (S9).

[Expression 8]

Enh=0 (8)

(a) and (b) of FIG. 6 are views illustrating an example of a high-frequency component generation process which is carried out by the high-frequency component generation processing section 19. Specifically, (a) of FIG. 6 illustrates a relation among an input pixel value, a maximum value maxVal, a minimum value minVal, an absolute difference value diffMax, an absolute difference value diffMin, and a high-frequency component Enh, in a case where the absolute difference value diffMax is larger than a result obtained by multiplying the absolute difference value diffMin by a predetermined constant value TH_RANGE. (b) of FIG. 6 illustrates a relation among an input pixel value, a maximum value maxVal, a minimum value minVal, an absolute difference value diffMax, an absolute difference value diffMin, and a high-frequency component Enh, in a case where the absolute difference value diffMin is larger than a result obtained by multiplying the absolute difference value diffMax by a predetermined constant value TH_RANGE.

In a case of (a) of FIG. 6, the high-frequency component is generated by subtracting the absolute difference value diffMax from the input pixel value which is near the minimum value, and a dynamic range can be increased. This makes an edge gradient, thereby improving detail. In a case of (b) of FIG. 6, the high-frequency component is generated by adding the absolute difference value diffMin to the input pixel value which is near the maximum value, and a dynamic range can be increased. This makes an edge gradient, thereby improving detail. In a case where (i) the absolute difference value diffMax is equal to or smaller than the result obtained by multiplying the absolute difference value diffMin by the predetermined constant value TH_RANGE and (ii) the absolute difference value diffMin is equal to or smaller than the result obtained by multiplying the absolute difference value diffMax by the predetermined constant value TH_RANGE, the input pixel value of an input pixel is near an intermediate value between the maximum value and the minimum value. Enhancing, in a given direction, the input pixel whose input pixel value is near the intermediate value causes the input pixel value to have (i) a pixel value which is near the minimum value and (ii) a pixel value which is near the maximum value. This results in impairing clarity. In this case, in order to prevent the clarity from being impaired, the high-frequency component Enh is set to zero.

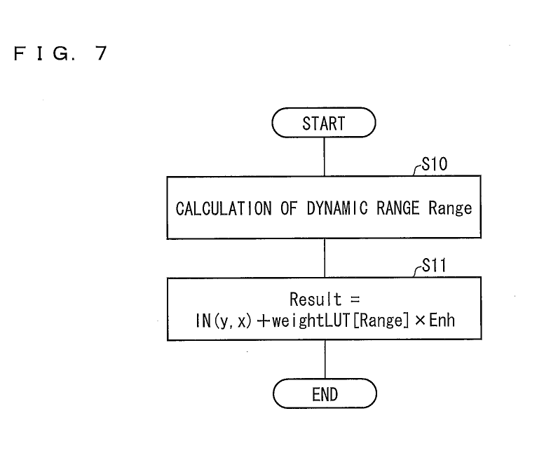

The mixing processing section 20 carries out a process of correcting an input pixel value that is a pixel value of an input pixel so as to improve detail. The present embodiment describes a case where the mixing processing section 20 carries out a mixing process that is a process of correcting the input pixel value using a high-frequency component calculated by the high-frequency component generation processing section 19, so as to improve detail. FIG. 7 is a flowchart illustrating a flow of the mixing process carried out by the mixing processing section 20. The mixing processing section 20 calculates, according to Expression (9) below, a dynamic range Range that is a difference value between a maximum value of and a minimum value of pixel values of respective I×J (e.g., 5×5) pixels including a target pixel in a center of the I×J pixels (S10).

$$[ Expression 9 ]$$

$$Range = {MAX}_{- I \text{/} 2 \leq i \leq I \text{/} 2} {MAX}_{- J \text{/} 2 \leq j \leq J \text{/} 2} IN ( y + i , x + j ) - {MIN}_{- I \text{/} 2 \leq i \leq I \text{/} 2} {MIN}_{- J \text{/} 2 \leq j \leq J \text{/} 2} IN ( y + i , x + j ) \qquad ( 9 )$$

The mixing processing section 20 then calculates a process result Result which enables the detail to be improved, by (i) employing the dynamic range Range as an address to search a weight coefficient table weightLUT for a return value weightLUT[Range], (ii) multiplying the return value weightLUT[Range] by the high-frequency component Enh calculated by the high-frequency component generation processing section 19, and (iii) adding a result of the multiplication to the pixel value (IN (y, x)) of the input pixel (S11). The process result Result is calculated according to Expression (10) below.

[Expression 10]

Result=IN(y,x)+weightLUT[Range]×Enh (10)

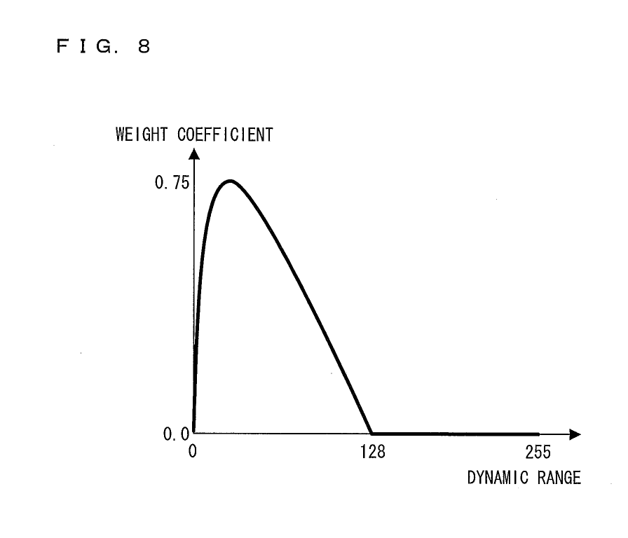

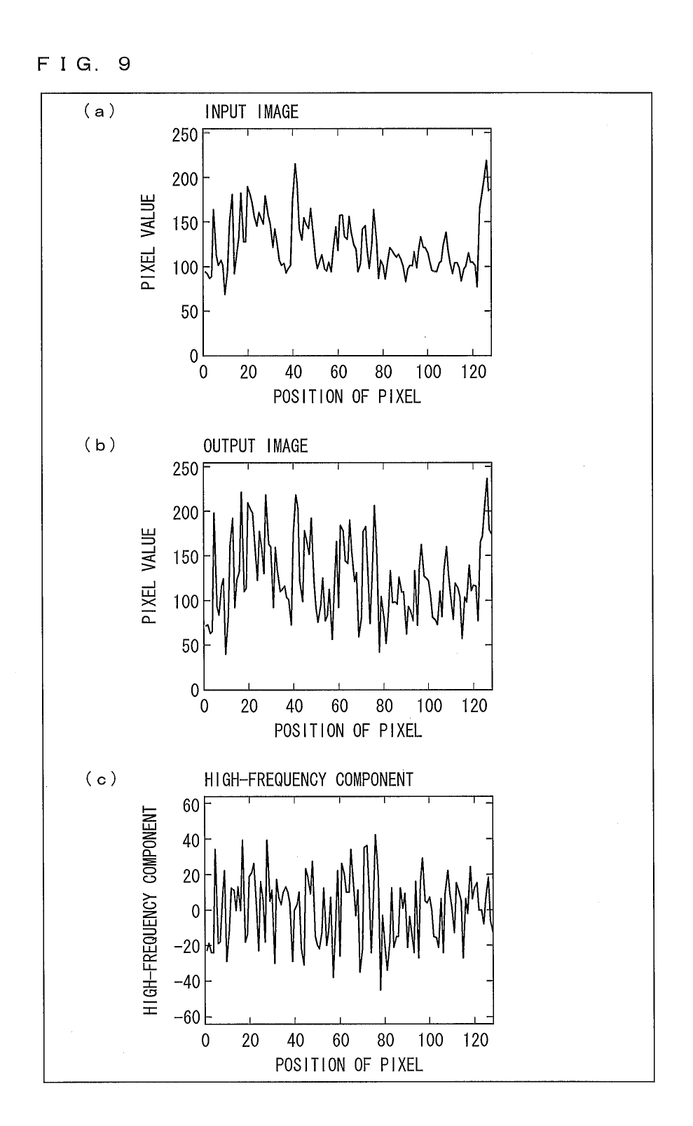

Instead of the weight coefficient table weightLUT which shows a relation between a dynamic range Range and a corresponding weight coefficient, for example, a curve line (see FIG. 8) which shows the relation can be used to find the corresponding weight coefficient based on the dynamic range Range. This curve line is stored in a storage section (not illustrated). In a case where the weight coefficient table weightLUT is used, the storage section (not illustrated) stores a weight coefficient associated with a dynamic range Range on a function of FIG. 8.

The weight coefficient has a large value for a first image region whose dynamic range is relatively small. The first image region is an image region after removal of a second image region whose dynamic range is extremely small. This makes it possible to remarkably improve detail. By decreasing a weight constant for an image region whose dynamic range is large, it is possible to improve detail without creating overshoot and undershoot.

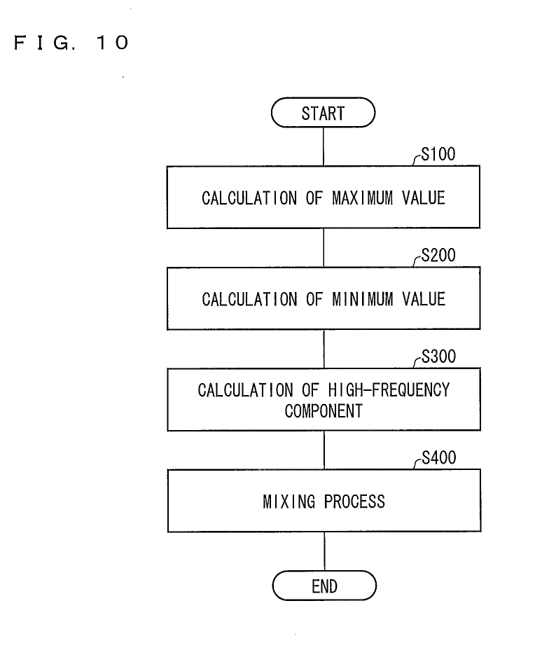

FIG. 10 illustrates a flow of processes (detail improvement process) carried out in the detail improvement processing section 13. First, a maximum value of pixel values of a block of a plurality of pixels including a target pixel is calculated (S100). Next, a minimum value of the pixel values is calculated (S200). Then, a high-frequency component of the target pixel is calculated based on (i) the pixel value of the target pixel, (ii) the maximum value calculated for the target pixel in S100, and (iii) the minimum value calculated for the target pixel in S200 (S300). Thereafter, a mixing process is carried out in which the pixel value of the target pixel is corrected using the high-frequency component calculated for the target pixel in S300 (S400). Note that the above processes S100 through S400 are carried out with respect to each of all input pixels.

As such, the detail improvement processing section 13 calculates a maximum value of and a minimum value of pixel values of a block of a respective plurality of pixels including a target pixel, and then calculates a high-frequency component on the basis of the target pixel value, the maximum value and the minimum value. In a case where a small mask size for a block is selected, the detail improvement processing section 13 can effectively calculate (generate), in the small mask size, a high-frequency component which brings clarity. By correcting a pixel value of a target pixel by use of this high-frequency component, the detail improvement processing section 13 can improve detail without (i) thickening a contour and (ii) enhancing an unnecessary frequency band. As such, the detail improvement processing section 13 can create image data of an image whose contour is not thickened but whose detail is improved.

Before an enlargement process, the detail improvement processing section 13 of the video signal processing section 42 does not enhance a strong contour component which causes a contour to be thickened noticeably, but enhances only a detail component. This allows the video signal processing section 42 to carry out the enlargement process without losing clarity. After the scaler processing section 14 carries out the enlargement process, the sharpness processing section 15 carries out a contour enhancement process. This allows the video signal processing section 42 to enhance a contour without thickening the contour.

As such, the detail improvement processing section 13 of the video signal processing section 42 improves detail before the detail is impaired by an interpolation calculation in an enlargement process, and then a contour enhancement process (sharpness process) is carried out after the enlargement process. This allows the video signal processing section 42 to improve sharpness and clarity without thickening a contour.

(a) of FIG. 9 shows an example of an input image (pixel values versus position of each pixel). (b) of FIG. 9 shows an example of an output image (pixel values versus position of each pixel) which is outputted from the detail improvement processing section 13 after being subjected to a detail improvement process. (c) of FIG. 9 shows an example of a high-frequency component (high-frequency versus position of each pixel) generated by the high-frequency component generation processing section 19. As is clear from (a) through (c) of FIG. 9, the output image has the high-frequency component added, whereas the input image does not have the high-frequency component added. The output image has remarkably improved detail thanks to the high-frequency component. As such, the detail improvement processing section 13 carries out a detail improvement process so as to improve detail before the detail is impaired by an interpolation calculation in an enlargement process, and then a sharpness process is carried out after the enlargement process. This makes it possible to improve sharpness and clarity without thickening a contour.

In a case where a contour, which has been subjected to a contour enhancement process before an enlargement process, is enlarged in the enlargement process, the contour which has been enhanced is enlarged as it is. Consequently, the contour seems to a viewer to be thickened. This causes a problem that a natural image seems to the viewer to be unnatural. In a case where a detail component which brings clarity is not enhanced before an enlargement process, a high-frequency component which brings the clarity is lost by an interpolation calculation in the enlargement process. This makes it difficult to improve detail by enhancing the high-frequency component after the enlargement process. According to the present embodiment, however, a strong contour component which causes a contour to be thickened noticeably is not enhanced but only a detail component is enhanced before an enlargement process, as have been described. It is therefore possible to carry out the enlargement process without losing clarity. It is further possible to enhance the contour without thickening the contour, by carrying out a contour enhancement process after the enlargement process. This makes it possible to further naturally contour an image.

### Embodiment 2

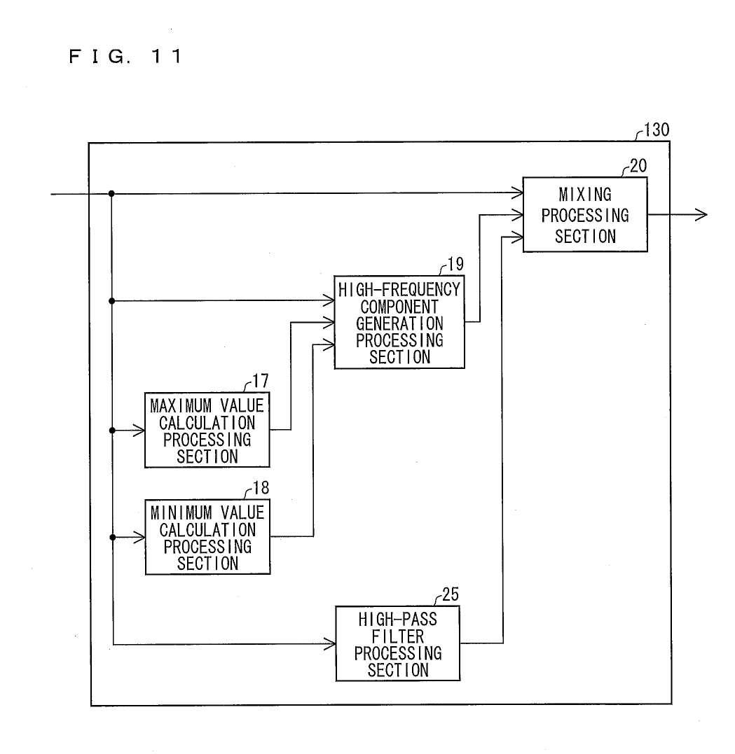

A video signal processing section of Embodiment 2 is different from the video signal processing section 42 of Embodiment 1 in including a detail improvement processing section (detail correction processing section) 130 (see FIG. 11) instead of the detail improvement processing section 13 (see FIG. 3). The video signal processing section of and a television broadcasting receiver of Embodiment 2 are identical to the video signal processing section 42 of and the television broadcasting receiver 1 of Embodiment 1 except for a configuration of the detail improvement processing section 130. Therefore, identical reference numerals are given to configurations identical to those described in Embodiment 1. Descriptions of processes described in Embodiment 1 are omitted in Embodiment 2.

The detail improvement processing section 130 of Embodiment 2 includes a high-pass filter processing section 25, in addition to a maximum value calculation processing section 17, a minimum value calculation processing section 18, a high-frequency component generation processing section 19, and a mixing processing section 20. That is, the detail improvement processing section 130 (see FIG. 11) of Embodiment 2 is identical in configuration to the detail improvement processing section 13 (see FIG. 3) of Embodiment 1 which includes the high-pass filter processing section 25.

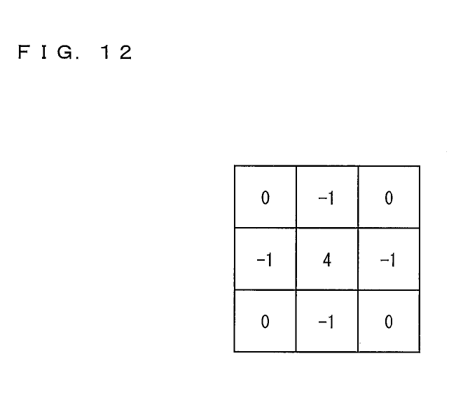

The high-pass filter processing section 25 carries out a high-pass filter process with respect to inputted image data so as to extract a high-frequency component of the inputted image data. That is, the high-pass filter processing section 25 carries out, for each input pixel, a high-pass filter process with respect to a target pixel so as to calculate a high-frequency component of the target pixel. FIG. 12 is a view illustrating an example of a high-pass filter constant value at which the high-pass filter processing section 25 of the detail improvement processing section 130 carries out a high-pass filter process. The high-pass filter processing section 25 carries out a high-pass filter process at, for example, the high-pass filter constant value illustrated in FIG. 12 so as to calculate a high-frequency component dFi1 according to Expression (11) below.

[Expression 11]

dFi1=IN(y,x)×4−IN(y−1,x)−IN(y,x−1)−IN(y,x+1)−IN(y+1,x) (11)

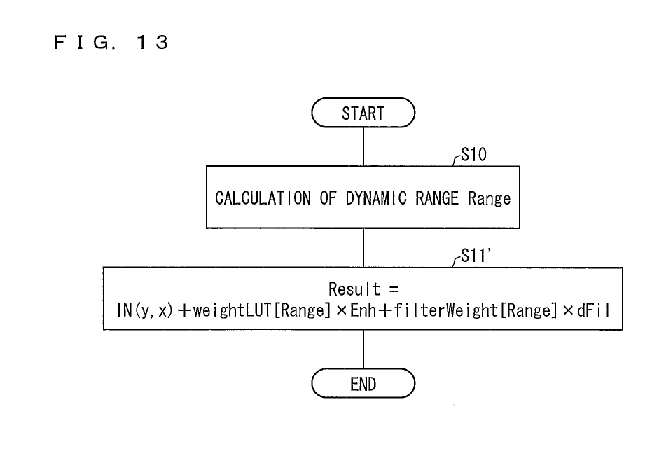

The mixing processing section 20 of Embodiment 2 carries out a mixing process that is a process for improving detail, by correcting an input pixel value that is a pixel value of an input pixel using (i) the input pixel value, (ii) a high-frequency component calculated by the high-frequency component generation processing section 19, and (iii) a high-frequency component calculated by the high-pass filter processing section 25. FIG. 13 illustrates a flowchart of a mixing process carried out by the mixing processing section 20 of Embodiment 2. The mixing processing section 20 first calculates, according to Expression (9), a dynamic range Range that is a difference value between a maximum value of and a minimum value of pixel values of respective I×J (e.g., 5×5) pixels including a target pixel in a center of the I×J pixels (S10).

The mixing processing section 20 then calculates a process result Result which enables detail to be improved, by (i) employing the dynamic range Range as an address to search a weight coefficient table weightLUT for a return value weightLUT[Range], (ii) multiplying the return value weightLUT[Range] by a high-frequency component Enh calculated by the high-frequency component generation processing section 19 to obtain a first multiplication result, (iii) employing the dynamic range Range as an address to search a weight coefficient table filterLUT for a return value filterLUT[Range], (iv) multiplying the return value filterLUT[Range] by a high-frequency component dFi1 calculated by the high-pass filter processing section 25 to obtain a second multiplication result, and (v) adding the first multiplication result and the second multiplication result to the pixel value (IN (y,x)) of the input pixel (S11′). The process result Result is calculated according to Expression (12) below.

[Expression 12]

Result=IN(y,x)+weightLUT[Range]×Enh+filterLUT[Range]×dFi1 (12)

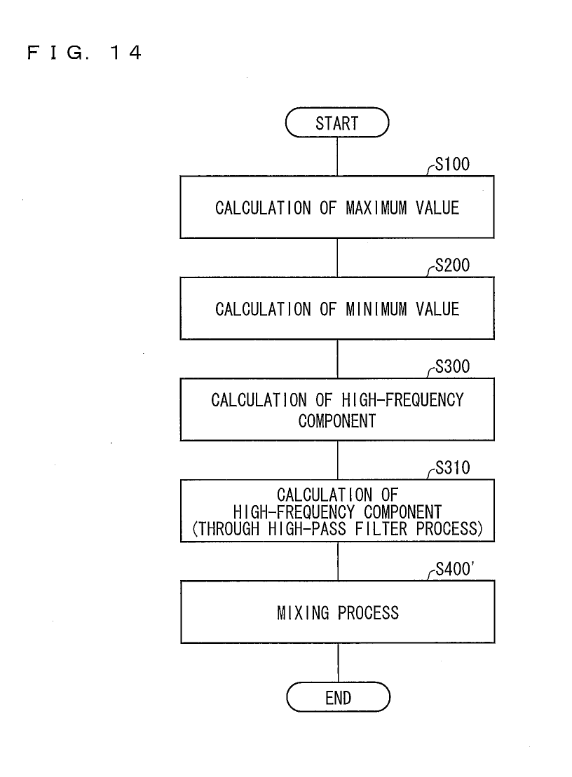

FIG. 14 illustrates a flow of processes which are carried out in the detail improvement processing section 130. S100, S200, and S300 are identical to those of Embodiment 1. In addition to these processes, the detail improvement processing section 130 of Embodiment 2 further carries out a high-pass filter process so as to calculate a high-frequency component (S310). Then, the detail improvement processing section 130 carries out a mixing process by correcting a pixel value of a target pixel using (i) a high-frequency component calculated in S300 and (ii) the high-frequency component calculated through the high-pass filter process in S310 (S400′).

As such, according to Embodiment 2, it is possible to add, to an input pixel value, not only a high-frequency component calculated based on a maximum value for and a minimum value for a pixel value of an input pixel (i.e., the input pixel value) but also a high-frequency component calculated through a high-pass filter process carried out by the high-pass filter processing section 25 (a high-frequency component calculated through a high-pass filter process), so as not to enhance an unnecessary high-frequency component. As such, a plurality of high-frequency components can be added to an input pixel value. This allows the detail improvement processing section 130 of Embodiment 2 to highly improve detail than the detail improvement processing section 13 of Embodiment 1 does.

### Embodiment 3

Each of Embodiments 1 and 2 has described a case where the image processing apparatus of the present invention is applied to the video signal processing section 42 of the television broadcasting receiver 1 that includes the tuner 3. Alternatively, the image processing apparatus of the present invention may be applied to, for example, a processing section which carries out a video signal process for a monitor (information display) that includes no tuner 3. In a case where the image processing apparatus of the present invention is applied to the processing section, the monitor corresponds to the image display apparatus of the present invention, and a schematic configuration of the monitor corresponds to the configuration, illustrated in FIG. 1, which includes no tuner 3. Since the image processing apparatus of the present invention is applied to the processing section which carries out the video signal process for the monitor, it is possible to carry out, in the monitor, a process for improving detail of an image.

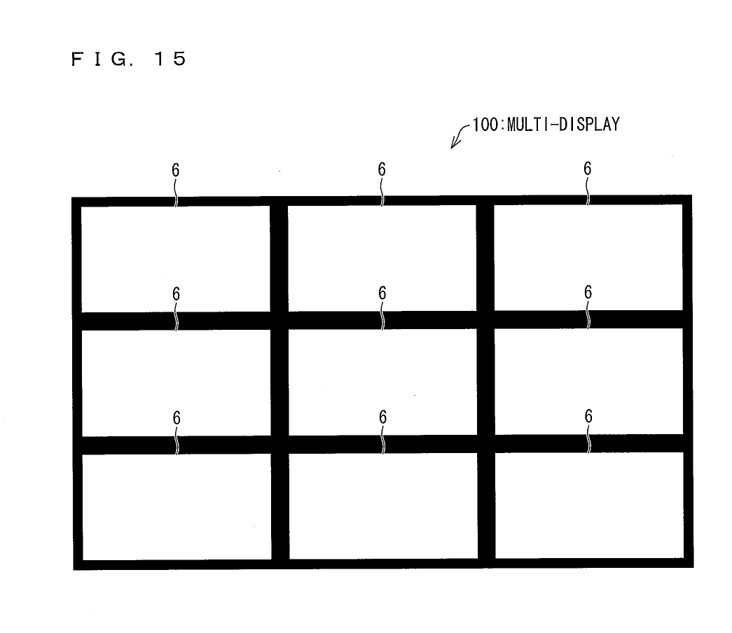

Each of Embodiments 1 and 2 has further described a case where the image processing apparatus of the present invention is applied to the video signal processing section 42 of the television broadcasting receiver 1 that includes one display section 6 (single display). Alternatively, the image processing apparatus of the present invention may be applied to, for example, a processing section which carries out a video signal process for a multi-display 100 in which a plurality of display sections 6 are arranged in a matrix manner (see FIG. 15). In a case where the image processing apparatus of the present invention is applied to the processing section, the multi-display 100 corresponds to the image display apparatus of the present invention. As such, the image processing apparatus of the present invention is applied to the processing section which carries out the video signal process for the multi-display 100. Therefore, for example, in a case where the multi-display 100 displays a full high definition (FHD) image, it is possible to carry out a process for improving detail of the FHD image.

### Embodiment 4

The video signal processing section 42 of Embodiment 1 or 2 may be configured by a hardware logic or may be realized by software as executed by a CPU as follows.

That is, the video signal processing section 42 (or the television broadcasting receiver 1) includes: a CPU (Central Processing Unit) that executes instructions of a control program that realizes the foregoing functions; a ROM (Read Only Memory) storing the control program; and a RAM (Random Access Memory) that develops the control program; and a storage device (storage medium) such as a memory which stores the control program and various kinds of data. The object of the present invention can be achieved, by mounting to the video signal processing section 42 a computer-readable storage medium storing a program code of the control program (executable program, intermediate code program, or source program) for the video signal processing section 42, the control program being software for realizing the foregoing functions, so that the computer (or CPU or MPU) retrieves and executes the program code stored in the storage medium.

The storage medium can be, for example, a tape, such as a magnetic tape or a cassette tape; a disk including (i) a magnetic disk such as a Floppy (Registered Trademark) disk or a hard disk and (ii) an optical disk such as CD-ROM, MO, MD, DVD, or CD-R; a card such as an IC card (memory card) or an optical card; a semiconductor memory such as a mask ROM, EPROM, EEPROM (Registered Trademark), or flash ROM; or a logic circuit such as a PLD (Programmable logic device).

Alternatively, the video signal processing section can be arranged to be connectable to a communications network so that the program code is made available to the video signal processing section 42 via the communications network. The communications network is not limited to a specific one, and therefore can be, for example, the Internet, Intranet, extranet, LAN, ISDN, VAN, CATV communications network, virtual dedicated network (virtual private network), telephone line network, mobile communications network, or satellite communications network. The transfer medium which constitutes the communications network is not limited to a specific one, and therefore can be, for example, wired line such as IEEE 1394, USB, electric power line, cable TV line, telephone line, or ADSL line; or wireless such as infrared radiation (IrDA, remote control), Bluetooth (Registered Trademark), IEEE 802.11 wireless, HDR (High Data Rate), NFC (Near Field Communication), DLNA (Digital Living Network Alliance), mobile telephone network, satellite line, or terrestrial digital network. Note that the present invention can also be implemented by the program code in the form of a computer data signal embedded in a carrier wave which is embodied by electronic transmission.

The present invention is not limited to the description of the embodiments above, and can therefore be modified by a skilled person in the art within the scope of the claims. Namely, an embodiment derived from a proper combination of technical means disclosed in different embodiments is encompassed in the technical scope of the present invention.

[Summary]

In order to attain the object, an image processing apparatus of the present invention is configured to include a detail correction processing section configured to correct detail of inputted image data, the detail correction processing section including: a maximum value calculation processing section configured to calculate, for each pixel of the inputted image data, a maximum value of pixel values of a block of a plurality of pixels that include a target pixel; a minimum value calculation processing section configured to calculate, for each pixel of the inputted image data, a minimum value of the pixel values of the block of the plurality of pixels that include the target pixel; a high-frequency component generation processing section configured to calculate, for each pixel of the inputted image data, a high-frequency component of the target pixel on the basis of (i) the pixel value of the target pixel, (ii) the maximum value calculated for the target pixel, and (iii) the minimum value calculated for the target pixel; and a mixing processing section configured to correct, for each pixel of the inputted image data, the pixel value of the target pixel, using the high-frequency component calculated for the target pixel.

According to the configuration, the detail correction processing section calculates the maximum value of and the minimum value of the pixel values of the block of the plurality of pixels that include the target pixel, and then calculates the high-frequency component on the basis of the target pixel value, the maximum value and the minimum value. In a case where a small block size is selected as the block, it is possible to effectively calculate (generate), in the small block size, a high-frequency component which brings clarity. By correcting a pixel value of a target pixel using this high-frequency component, it is possible to improve detail without (i) thickening a contour and (ii) enhancing an unnecessary frequency band. Note that a pixel value does not represent a position coordinate of a corresponding pixel, but represents a value which falls within a range from 0 to 255 in a case where inputted image data is 8-bit data.

As such, according to the configuration, it is possible to create image data of an image whose detail is improved without thickening a contour of the image.

In addition to the above configuration, the image processing apparatus of the present invention may further be configured so that the mixing processing section adds, to the pixel value of the target pixel, a multiplication result obtained by multiplying, by the high-frequency component calculated for the target pixel, a weight coefficient determined on the basis of a dynamic range of the block of the plurality of pixels that include the target pixel.

According to the configuration, detail is corrected by adding, to the pixel value of the target pixel, the multiplication result obtained by multiplying, by the high-frequency component calculated for the target pixel, the weight coefficient determined on the basis of the dynamic range of the block of the plurality of pixels that include the target pixel. Note here that it is possible to improve detail by determining a weight coefficient so as to increase the weight coefficient for a first image region whose dynamic range is relatively small, the first image region excluding a second image (pixel) region whose dynamic range is extremely small. Note also that a dynamic range can be calculated from a difference between a maximum value of and a minimum value of pixel values of a block of a plurality of pixels including a target pixel.

In addition to the above configuration, the image processing apparatus of the present invention may further be configured so that (a) the high-frequency component generation processing section calculates, as the high-frequency component of the target pixel, a value obtained by subtracting, from the pixel value of the target pixel, the maximum value calculated for the target pixel, in a case where a first absolute value of a difference between the pixel value of the target pixel and the maximum value calculated for the target pixel is larger than a value obtained by multiplying, by a constant value, a second absolute value of a difference between the pixel value of the target pixel and the minimum value calculated for the target pixel, and

(b) the high-frequency component generation processing section calculates, as the high-frequency component of the target pixel, a value obtained by subtracting, from the pixel value of the target pixel, the minimum value calculated for the target pixel, in a case where the second absolute value of the difference between the pixel value of the target pixel and the minimum value calculated for the target pixel is larger than a value obtained by multiplying, by the constant value, the first absolute value of the difference between the pixel value of the target pixel and the maximum value calculated for the target pixel.

According to the configuration, it is possible to calculate a high-frequency component through a simple process of the above-described (a) or (b). It is therefore possible to efficiently calculate (generate) the high-frequency component.

In addition to the above configuration, the image processing apparatus of the present invention may further be configured so that the detail correction processing section further includes a high-pass filter processing section configured to carry out, for each pixel of the inputted image data, a high-pass filter process with respect to the target pixel so as to calculate a high-frequency component of the target pixel through the high-pass filter process, and the mixing processing section corrects the pixel value of the target pixel using (i) the high-frequency component calculated for the target pixel by the high-frequency component generation processing section and (ii) the high-frequency component calculated for the target pixel through the high-pass filter process by the high-pass filter processing section.

According to the configuration, the pixel value of the target pixel is corrected using (i) the high-frequency component calculated for the target pixel by the high-frequency component generation processing section and (ii) the high-frequency component calculated for the target pixel through the high-pass filter process by the high-pass filter processing section. It is therefore possible to enhance a high-frequency component so as not to enhance an unnecessary high-frequency component. This allows a further improvement of detail.

In addition to the above configuration, the image processing apparatus of the present invention may further be configured to include: a scaler processing section configured to carry out an enlargement process with respect to image data outputted from the detail correction processing section; and a sharpness processing section configured to carry out a contour enhancement process with respect to the image data outputted from the scaler processing section.

According to the configuration, before an enlargement process, the detail correction processing section does not enhance a strong contour component which causes a contour to be thickened noticeably but enhances only a detail component. It is therefore possible to carry out the enlargement process without losing clarity. After the scaler processing section carries out the enlargement process, the sharpness processing section carries out a contour enhancement process. It is therefore possible to enhance the contour without thickening the contour. This makes it possible to further naturally contour an image.

As such, according to the image processing apparatus of the present invention, the detail correction processing section improves detail before the detail is impaired by an interpolation calculation in an enlargement process, and then a contour enhancement process (sharpness process) is carried out after the enlargement process. This makes it possible to improve sharpness and clarity without thickening a contour.

In order to attain the object, an image display apparatus of the present invention is configured to include any one of the above-described image processing apparatuses. Since the image display apparatus of the present invention includes the image processing apparatus of the present invention, it is possible to create image data of an image whose sharpness and clarity are improved without thickening a contour of the image. This allows the image display apparatus to display a high-quality and high-definition image. It is therefore possible to provide a user with a high-performance and comfortable viewing environment.

In order to attain the object, an image processing method of the present invention is configured to be an image processing method including the step of correcting detail of inputted image data, the detail correcting step comprising the steps of: calculating, for each pixel of the inputted image data, a maximum value of pixel values of a block of a plurality of pixels that include a target pixel; calculating, for each pixel of the inputted image data, a minimum value of the pixel values of the block of the plurality of pixels that include the target pixel; calculating, for each pixel of the inputted image data, a high-frequency component on the basis of (i) the pixel value of the target pixel, (ii) the maximum value calculated for the target pixel, and (iii) the minimum value calculated for the target pixel; and correcting, for each pixel of the inputted image data, the pixel value of the target pixel, using the high-frequency component calculated for the target pixel.

According to the image processing method, it is possible to provide an image processing method which (i) brings about an effect identical to that brought about by the image processing apparatus and (ii) is capable of, without thickening a contour, creating image data of an image whose detail is improved.

Note that the image processing apparatus of the present invention may be realized by a computer. In a case where the image processing apparatus of the present invention is realized by a computer, the present invention encompasses (i) a program for causing the computer to function as each of the sections of the image processing apparatus so as to realize the image processing apparatus by the computer and (ii) a non-transitory computer-readable storage medium in which the program is stored.

### INDUSTRIAL APPLICABILITY

The present invention is applicable to, for example, an image processing apparatus which improves detail of a static image or a moving image without thickening a contour of the static image or the moving image.

### REFERENCE SIGNS LIST

1: Television broadcasting receiver (image display apparatus)
4: Control section
6: Display section
8: Operation section
13 and 130: Detail improvement processing section (detail correction processing section)
17: Maximum value calculation processing section
18: Minimum value calculation processing section
19: High-frequency component generation processing section
20: Mixing processing section
25: High-pass filter processing section
42: Video signal processing section (image processing apparatus)

1. An image processing apparatus comprising a detail correction processing section configured to correct detail of inputted image data,
the detail correction processing section comprising:
a maximum value calculation processing section configured to calculate, for each pixel of the inputted image data, a maximum value of pixel values of a block of a plurality of pixels that include a target pixel;
a minimum value calculation processing section configured to calculate, for each pixel of the inputted image data, a minimum value of the pixel values of the block of the plurality of pixels that include the target pixel;
a high-frequency component generation processing section configured to calculate, for each pixel of the inputted image data, a high-frequency component of the target pixel on the basis of (i) the pixel value of the target pixel, (ii) the maximum value calculated for the target pixel, and (iii) the minimum value calculated for the target pixel; and
a mixing processing section configured to correct, for each pixel of the inputted image data, the pixel value of the target pixel, using the high-frequency component calculated for the target pixel.

2. The image processing apparatus as set forth in claim 1, wherein the mixing processing section adds, to the pixel value of the target pixel, a multiplication result obtained by multiplying, by the high-frequency component calculated for the target pixel, a weight coefficient determined on the basis of a dynamic range of the block of the plurality of pixels that include the target pixel.

3. The image processing apparatus as set forth in claim 1, wherein (a) the high-frequency component generation processing section calculates, as the high-frequency component of the target pixel, a value obtained by subtracting, from the pixel value of the target pixel, the maximum value calculated for the target pixel, in a case where a first absolute value of a difference between the pixel value of the target pixel and the maximum value calculated for the target pixel is larger than a value obtained by multiplying, by a constant value, a second absolute value of a difference between the pixel value of the target pixel and the minimum value calculated for the target pixel, and
(b) the high-frequency component generation processing section calculates, as the high-frequency component of the target pixel, a value obtained by subtracting, from the pixel value of the target pixel, the minimum value calculated for the target pixel, in a case where the second absolute value of the difference between the pixel value of the target pixel and the minimum value calculated for the target pixel is larger than a value obtained by multiplying, by the constant value, the first absolute value of the difference between the pixel value of the target pixel and the maximum value calculated for the target pixel.

4. The image processing apparatus as set forth in claim 2, wherein (a) the high-frequency component generation processing section calculates, as the high-frequency component of the target pixel, a value obtained by subtracting, from the pixel value of the target pixel, the maximum value calculated for the target pixel, in a case where a first absolute value of a difference between the pixel value of the target pixel and the maximum value calculated for the target pixel is larger than a value obtained by multiplying, by a constant value, a second absolute value of a difference between the pixel value of the target pixel and the minimum value calculated for the target pixel, and
(b) the high-frequency component generation processing section calculates, as the high-frequency component of the target pixel, a value obtained by subtracting, from the pixel value of the target pixel, the minimum value calculated for the target pixel, in a case where the second absolute value of the difference between the pixel value of the target pixel and the minimum value calculated for the target pixel is larger than a value obtained by multiplying, by the constant value, the first absolute value of the difference between the pixel value of the target pixel and the maximum value calculated for the target pixel.

5. The image processing apparatus as set forth in claim 1, wherein the detail correction processing section further includes a high-pass filter processing section configured to carry out, for each pixel of the inputted image data, a high-pass filter process with respect to the target pixel so as to calculate a high-frequency component of the target pixel through the high-pass filter process, and
the mixing processing section corrects the pixel value of the target pixel using (i) the high-frequency component calculated for the target pixel by the high-frequency component generation processing section and (ii) the high-frequency component calculated for the target pixel through the high-pass filter process by the high-pass filter processing section.

6. The image processing apparatus as set forth in claim 1, comprising:
a scaler processing section configured to carry out an enlargement process with respect to image data outputted from the detail correction processing section; and
a sharpness processing section configured to carry out a contour enhancement process with respect to the image data outputted from the scaler processing section.

7. An image display apparatus, comprising the image processing apparatus as set forth in claim 1.

8. An image processing method comprising the step of correcting detail of inputted image data,
the detail correcting step comprising the steps of:
calculating, for each pixel of the inputted image data, a maximum value of pixel values of a block of a plurality of pixels that include a target pixel;
calculating, for each pixel of the inputted image data, a minimum value of the pixel values of the block of the plurality of pixels that include the target pixel;
calculating, for each pixel of the inputted image data, a high-frequency component on the basis of (i) the pixel value of the target pixel, (ii) the maximum value calculated for the target pixel, and (iii) the minimum value calculated for the target pixel; and
correcting, for each pixel of the inputted image data, the pixel value of the target pixel, using the high-frequency component calculated for the target pixel.

9. A non-transitory computer-readable storage medium in which a program for causing the image processing apparatus as set forth in claim 1 to operate is stored, the program causing a computer to function as each of the sections of the image processing apparatus.
